(19) United States
(12) Patent Application Publication
(10) Pub. No.: US 2023/0230444 A1
(43) Pub. Date: Jul. 20, 2023

(54) ODDS PREDICTION WAGERS FOR FUTURE SPORTING EVENT WAGERS

(71) Applicant: IGT, Las Vegas, NV (US)

(72) Inventor: Prasad INAMDAR, San Francisco, CA (US)

(21) Appl. No.: 17/576,613

(22) Filed: Jan. 14, 2022

(51) Int. Cl. G07F 17/32

(52) U.S. Cl. CPC G07F 17/323

(57) ABSTRACT

A system includes a processor circuit and a memory having machine-readable instructions that cause the processor circuit to receive data associated with an identification of a future offer wager on a future offer of a sporting event wager. The future offer wager includes a wager amount and a predicted value for a wager parameter associated with the sporting event wager. The instructions further cause the processor circuit to cause a placement of the future offer wager, and to determine an actual value for the wager parameter of the sporting event wager. The instructions further cause the processor circuit to compare the predicted value to the actual value of the wager parameter to determine a result of the future offer wager, and, in response to a determination that the future offer wager is successful, provide an award based on the comparison and the wager amount.

### BACKGROUND

Embodiments described herein relate to game play features for sports wagers, and in particular to odds prediction wagers for sporting event wagers, such as in a casino environment, and/or mobile wagering environment, and related devices, systems, and methods.

Live sporting events have many aspects that make them attractive to spectators, both from an entertainment standpoint and a wagering and/or betting standpoint. Many types of sports wagers have associated odds. As technology improves and as the competition for the attention of bettors and spectators increases, there is a need for additional wagers and customization features that increase player involvement and excitement.

### BRIEF SUMMARY

According to some embodiments, a system includes a processor circuit and a memory having machine-readable instructions. When executed by the processor circuit, the instructions cause the processor circuit to receive data associated with an identification of a future offer wager on a future offer of a sporting event wager. The future offer wager includes a wager amount and a predicted value for a wager parameter associated with the sporting event wager. The instructions further cause the processor circuit to cause a placement of the future offer wager. The instructions further cause the processor circuit to determine an actual value for the wager parameter of the sporting event wager. The instructions further cause the processor circuit to compare the predicted value to the actual value of the wager parameter to determine a result of the future offer wager. The instructions further cause the processor circuit to, in response to a determination that the future offer wager is successful, provide an award based on the comparison and the wager amount.

According to some embodiments, a gaming device includes a display device, an input device, a processor circuit, and a memory having machine-readable instructions. When executed by the processor circuit, the instructions cause the processor circuit to display, by the display device, an offer of a future offer wager on a future offer of a sporting event wager. The instructions further cause the processor circuit to receive, by the input device, a selection of a predicted value for a wager parameter associated with the sporting event wager. Based on receipt of the selected predicted value, the instructions further cause the processor circuit to cause a placement of the future offer wager comprising the predicted value selection and a wager amount. Based on a comparison of the selected predicted value and an actual value for the wager parameter of the sporting event wager, the instructions further cause the processor circuit to provide an indication of a result of the future offer wager. Based on a determination that the future offer wager is successful, the instructions further cause the processor circuit to provide an award based on the comparison and the wager amount.

According to some embodiments, a method includes receiving, by a processor circuit, data associated with an identification of a future offer wager on a future offer of a sporting event wager. The future offer wager includes a predicted value for a wager parameter associated with the sporting event wager. The method further includes placing of the future offer wager by the processor circuit. The method further includes comparing, by the processor circuit, the predicted value to an actual value of the wager parameter to determine a result of the future offer wager. The method further includes, in response to a determination that the future offer wager is successful, providing an award based on the comparison.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2 is a flowchart illustrating operations of systems/methods of facilitating wagering on predicted odds for future sporting event wagers, according to some embodiments.

FIG. 3 is a more detailed flowchart illustrating examples of the operations of FIG. 2 and additional operations of systems/methods of facilitating wagering on predicted odds for future sporting event wagers, according to some embodiments.

FIG. 4 illustrates a graphical user interface (GUI) for placing wagers on predicted odds for future sporting event wagers, according to some embodiments.

FIGS. 5A-5B illustrate a graphical user interface (GUI) for placing a wager on predicted odds for a plurality of future sporting event wagers, according to some embodiments.

FIG. 6A is a perspective view of a gaming device that can be configured according to some embodiments.

FIG. 6B is a schematic block diagram illustrating an electronic configuration for a gaming device according to some embodiments.

FIG. 6C is a schematic block diagram that illustrates various functional modules of a gaming device according to some embodiments.

FIG. 6D is perspective view of a gaming device that can be configured according to some embodiments.

FIG. 7 Illustrates an example of a pay table for odds prediction wagers, including wagers associated with the selected wagers of FIG. 4, according to some embodiments.

### DETAILED DESCRIPTION

Embodiments described herein relate to game play features for sports wagers, and in particular to odds prediction wagers for sporting event wagers, such as in a casino environment, and/or mobile wagering environment, and related devices, systems, and methods.

Sportsbooks select and modify different wagers and associated criteria, such as lines, spreads, potential payouts, etc., to allow players to wager on sporting event results and other events that may occur during the sporting events. To maximize the amount wagered on the sporting event while minimizing the sportsbook's risk, sportsbooks generally select wagers and criteria to encourage betting on both results, e.g., selecting a point spread to discourage betting on a favorite and encourage betting on an underdog, offering more favorable money-line odds for an underdog and less favorable odds for a favorite, etc.

In embodiments described herein, players can make predictions associated with the wagers and criteria before the wagers are offered, e.g., before the lines are released, and make wagers based on those predictions. The future offer wagers are resolved when the sporting event wagers are offered, which may generally be before the sporting event occurs and before the sporting event wager itself is resolved. Advantages of these and other embodiments include providing additional betting opportunities for players to increase player enjoyment and providing operators with additional data and insight into player behavior and preferences.

For example, in some embodiments, data associated with an identification of a future offer wager on a future offer of a sporting event wager is received, the future offer wager including a wager amount and a predicted value for a wager parameter associated with the sporting event wager. The future offer wager, and an actual value for the wager parameter of the sporting event wager is later determined. Based on a comparison of the predicted value to the actual value of the wager parameter, a result of the future offer wager is determined, and, if applicable, an award based on the comparison and the wager amount. These and other embodiments address the technical problem of obtaining greater player engagement and insight into player preferences by a technical solution that incorporates these and other types of desired player interaction into a game format, thereby increasing player engagement and enjoyment.

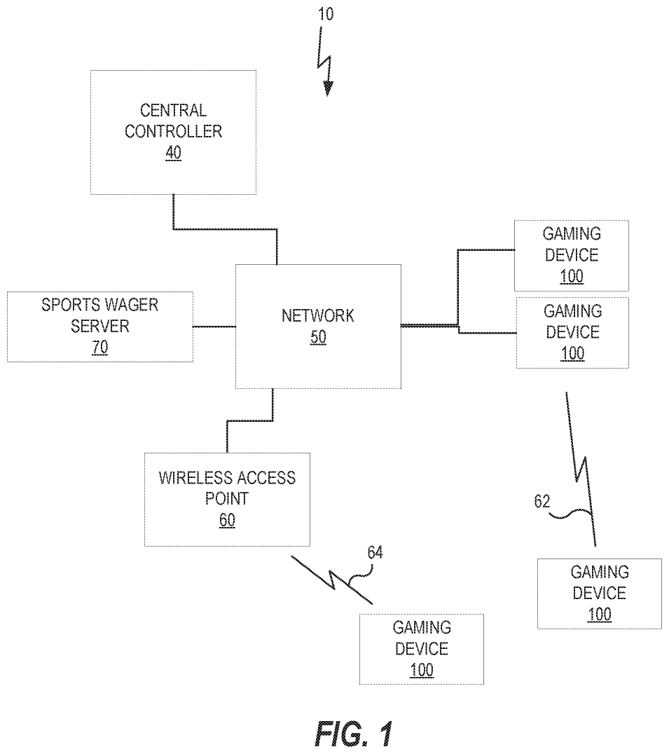

Embodiments disclosed herein can be implemented manually or electronically. In this regard, FIG. 1 illustrates a gaming system 10 including a plurality of gaming devices 100. The gaming devices 100 may be one type of a variety of different types of gaming devices, such as electronic gaming machines (EGMs), electronic sports betting kiosks, mobile gaming devices, or other devices, for example. The gaming system 10 may be located, for example, on the premises of a gaming establishment, such as a permitted betting location, or may be internet-based, such as a game server in communication with a plurality of personal mobile devices (e.g., phones or tablets) of individual players. The gaming device 100 may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processing circuit and at least one memory or storage device. Each gaming device 100 may include a processing circuit that transmits and receives events, messages, commands or any other suitable data or signal between the gaming device 100 and the central controller 40. The gaming device processing circuit is operable to execute such communicated events, messages or commands in conjunction with the operation of the gaming device 100. Moreover, the processing circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processing circuits. Moreover, in some embodiments, one or more of the functions of one or more gaming device processing circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

In this example, a sports wager server 70 controls and manages sports wagers, such as multi-game sports wagers for example, across multiple gaming devices 100. In this simplified example, the eligible gaming devices 100 are interconnected though a common data communication network 50, but as will be described in greater detail below, it should be understood that eligible gaming devices 100 may facilitate wagering across a plurality of networks, which located across different locations, properties, and/or jurisdictions, etc.

The gaming devices 100 communicate with one or more elements of the gaming system 10 to coordinate providing wagering games and other functionality. For example, in some embodiments, the gaming device 100 may communicate directly with other gaming devices 100 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. Some embodiments provide that gaming devices 100 may communicate with other gaming devices over a wireless interface 64. In these embodiments, wireless interface 62 and/or wireless interface 64 may use different communication protocols and/or different communication resources, such as different frequencies, time slots, spreading codes, etc.

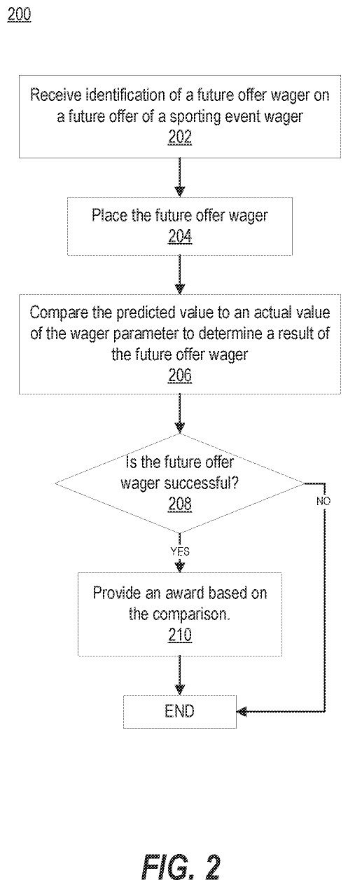

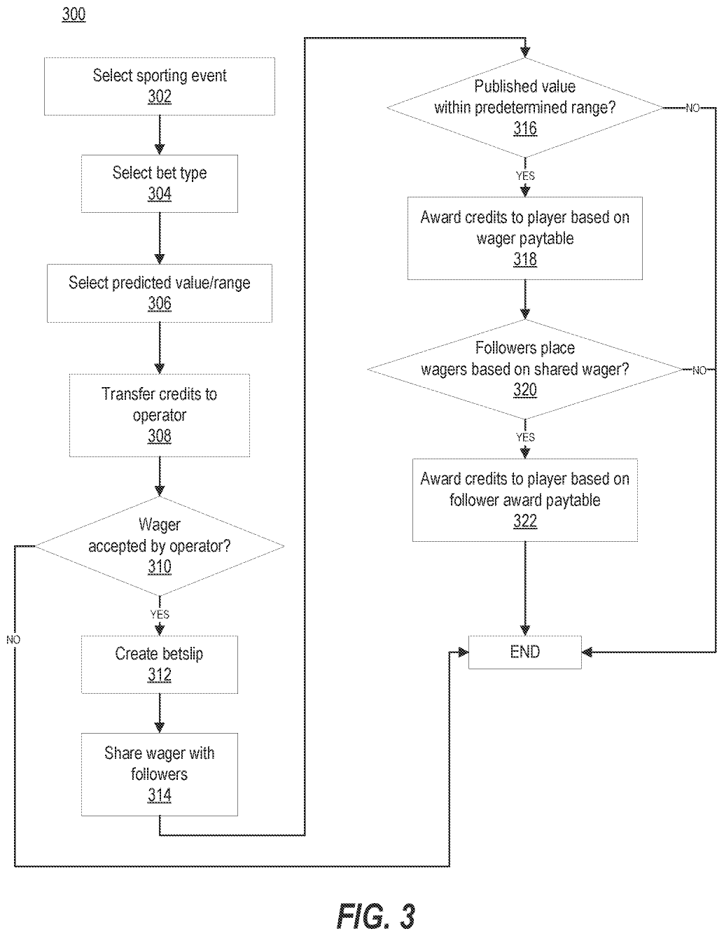

FIG. 2 is a flowchart illustrating operations 200 of systems/methods of facilitating wagering on predicted odds for future sporting event wagers, according to some embodiments. In this regard, the operations 200 may include receiving an identification of a future offer wager on a future offer of a sporting event wager (Block 202). As discussed in greater detail with respect to FIG. 3, a future offer wager may include a predicted point spread, money line odds, point total line, or other parameter of the future sports wager. The operations 200 may further include placing the future offer wager (Block 204).

The operations 200 may also include comparing the predicted value to an actual value of the wager parameter to determine a result of the future offer wager (Block 206). For example, a predicted point spread of the future offer wager may be compared to an actual point spread when the bet is first offered or at another predetermined future time, e.g., at game time, one hour before game time, etc. The operations 200 include determining if the future wager is successful (Block 208). If the future wager is not successful, the operations 200 end. If the future wager is successful, an award is provided based on the comparison (Block 210). For example, if the predicted point spread for the sports wager is the same as or within a predetermined range of the actual point spread, an award may be paid out to the player based on a pay table.

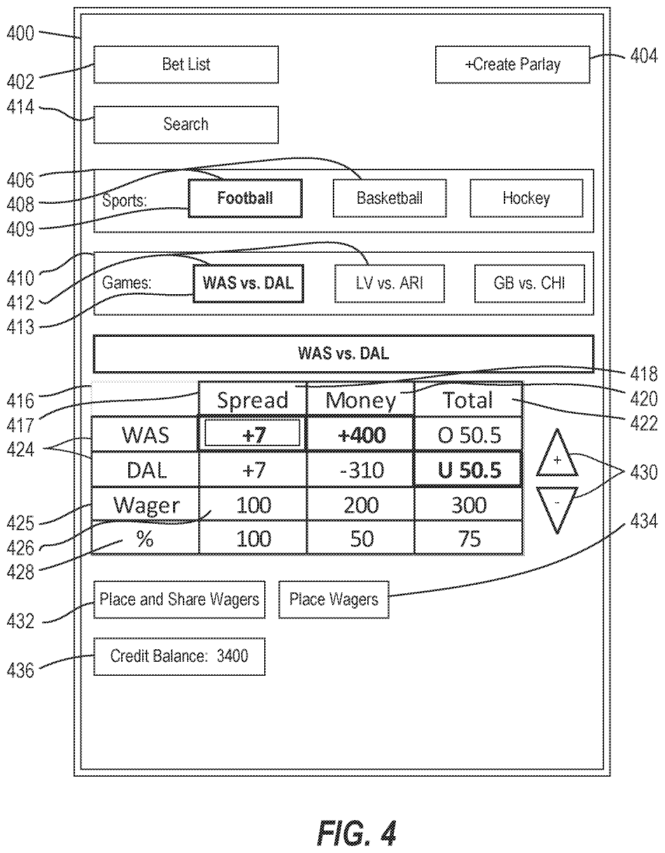

Referring now to FIG. 3, a more detailed flowchart illustrating operations 300 of systems/methods of facilitating wagering on predicted odds for future sporting event wagers, according to some embodiments. The operations 300 may correspond to the operations 200 of FIG. 2, and may also include additional operations. The operations 300 will also be described in connection with the example illustrated by FIG. 4, including a graphical user interface (GUI) 400 for placing wagers on predicted odds for future sporting event wagers, according to some embodiments.

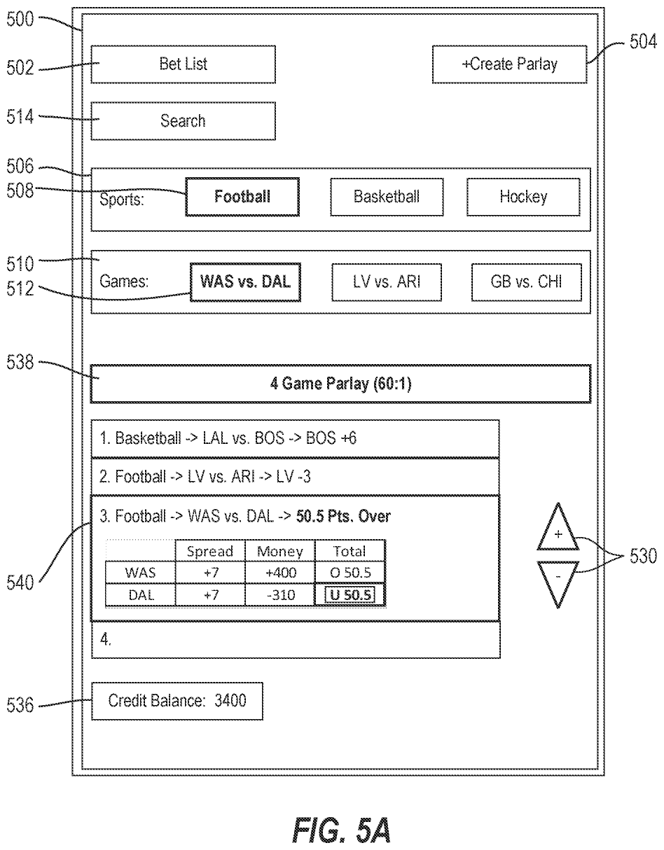

In this regard, the operations 300 of FIG. 3 may include selecting a specific sporting event (Block 302) and a specific bet type (Block 304) for a future offer wager. For example, as shown in FIG. 4, a GUI 400 includes a number of interface elements, including a bet list button 402 for displaying a list of available sporting event wagers. The GUI 400 may also include a parlay creation button 404, which will be described in greater detail with respect to FIGS. 5A-5B. The GUI 400 may also include a search area 414, for locating and identifying specific sports, games, and wagers, etc. The GUI 400 includes a sport selection area 406 with a number of available sports 408. In this example, the selection of football 409 displays a plurality of available games 412 in a game selection area 410. The selection of WAS vs. DAL 413 in this example causes a plurality of available wagers 417 to be displayed in a bet selection area 416 of the GUI 400. The available wagers 417 may include point spreads 418 and money lines 420 associated with the different teams 424, and point totals 422, i.e., over/under wagers, for the selected game, for example.

The operations 300 of FIG. 3 may further include selecting a predicted value and/or range of values for the selected sport and bet type (Block 306). In this example, operations 302-306 correspond to the identification of a future offer wager operation (Block 202) of FIG. 2. In the embodiment of FIG. 4, for example, the WAS +7 wager 425 is selected, and the predicted point spread can be increased or decreased using arrow buttons 430 for example or another suitable interface element and/or input method. The player may also enter a wager amount 426 for each odds prediction wager.

In some embodiments, the player may also indicate a confidence level 428 for each wager, which may result in a wider range of winning values for the odds prediction wager, or may result in a different pay table. For example, the player in this embodiment has indicated 100% confidence in his prediction that the spread will open at WAS +7. As a result, the spread must open at exactly WAS +7 to win, and the potential payout may be increased. For the prediction of WAS +400 money line, however, the confidence level is only 50%, which may allow for a larger range of winning results, e.g., +300 to +500, but with a lower potential payout to compensate for the increased probability of a successful result.

The operations 300 of FIG. 3 may further include transferring credits to an operator (Block 308). For example, the GUI 400 may further include a Place and Share Wagers button 432 and/or a separate Place Wagers button 434, which initiate placement of the wager and transfer of the credits from the player's credit balance 436.

The operations 300 of FIG. 3 may further include determining whether the selected wager is accepted by the operator (Block 310). If the selected wager is not accepted, the operations end. A wager might not be accepted for a variety of reasons, such as an authentication failure or error, network traffic, expiration of a time limit, and/or a decision by the operator to stop accepting wagers, for example. If the selected wager is accepted, a betslip is created (Block 312). In this example, operations 308-312 correspond to the placement of the future offer wager operation (Block 204) of FIG. 2.

The operations 300 of FIG. 3 may further include sharing the placed wager with other individuals, e.g., social media followers (Block 314). In the example of FIG. 4, the Place and Share Wagers button 432 causes the wager to be shared with the players contacts, e.g., followers, and/or to the general public. In some embodiments, these other individuals can place their own odds predictions wagers based on the original shared wager. This feature provides an additional benefit to the player by allowing communication with other individuals about the player's wagering activity, which can promote competition between players to outperform each other, and to give other individuals additional rooting interests in certain game outcomes, thereby increasing the entertainment value of the wagering activity.

The operations 300 of FIG. 3 may further include determining whether a published value for the sports wager is within a predetermined range (Block 316). Operation 316 corresponds to the comparison of the predicted value to the actual value operation (Block 206) and determination of whether the future offer wager is successful operation (Block 208) of FIG. 2. As noted above, the predetermined range may correspond exactly to the predicted value, or may be a larger range that includes the predicted value, and there may be different potential payouts associated with the different ranges. As also noted above, the published value may be set at a specific time, e.g., Sunday at 8:00 pm, 9:00 am on the day of the game, one hour before game time, etc.

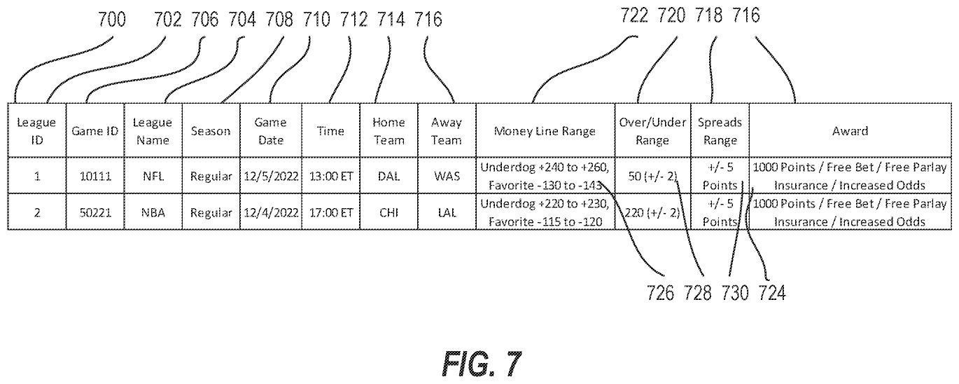

If the published value for the sports wager is not within the predetermined range, the operations 300 end. If the published value is within the predetermined range, credits may be awarded to the player based on a wager pay table associated with the future offer wager (Block 318). Operation 318 correspond to the providing an award operation (Block 210) of FIG. 2. For example, FIG. 7 Illustrates an example of a pay table 700 for the selected wagers 425 associated with the selected game (i.e., WAS vs. DAL) 413 of FIG. 4, and other games.

In this regard, the pay table 700 of FIG. 7 includes a number of fields for identifying and correlating the parameters of different games with different payouts. In this example, the pay table 700 includes a League ID field 702 and a League Name field 704, for identifying the selected sport. The pay table 700 also includes a Game ID field 706 for identifying the selected game, a Season field 708 (e.g., regular season/playoffs/etc.), a Game Date field 710 and Time field 712, and fields for the Home Team 714 and Away Team 716. In this example, the pay table 700 includes an Award field 716 with a predetermined award associated with successful odds predictions, i.e., odds predictions within predetermined ranges, e.g., within the Spread Range field 718, Over/Under Range field 720, and/or Money Line Range field 722.

In this example, the first paytable entry 1-10111 (corresponding to the WAS vs. DAL game 413 of FIG. 4), can award 1000 points, a free bet, free parlay insurance, and/or improved odds on a future wager (Entry 724) if any of a player's successful odds predictions are within the specified ranges, e.g., a money line of between +240 and +260 on the underdog, between −130 and −143 on the favorite (Entry 726), an over/under of 50+/−2 (Entry 728), and/or a spread between +5 and −5 (Entry 730). It should be understood that this example can be modified, simplified, enhanced, or replaced with different types of pay tables and/or award structures, as desired.

The operations 300 may also include determining whether other individuals, e.g., social media followers, have placed future offer wagers based on the wager that was shared in operation 314 (Block 320). In some embodiments, it may also be determined if a sufficient number of individuals have placed future offer wagers based on the shared wager. If individuals (or a sufficient number of individuals) have not placed future offer wagers based on the shared wager, the operations 300 end. If individuals (or a sufficient number of individuals) have placed future offer wagers based on the shared wager, additional credits may be awarded to the player based on a follower award pay table (Block 322). This may provide an additional monetary incentive to the player to share his odds prediction wagers.

In addition to placing future odds wagers individually, in some embodiments, an individual future odds wager can be placed on plurality of future sporting event wagers, e.g., on a parlay wager. In a typical parlay wager, a player must correctly select outcomes for all of the plurality of wagers, with the payout odds adjusted accordingly. Accordingly, for some embodiments, the future odds prediction wager can be based on an odds prediction for a particular parlay wager with specific individual wagers. In this regard, FIGS. 5A-5B illustrate a graphical user interface (GUI) for placing a wager on predicted odds for a plurality of future sporting event wagers, according to some embodiments.

Referring now to FIG. 5A, a GUI 500 may include a bet list 502, a Create Parlay button 504, a search area 514, and a credit balance display 536, similar the embodiment of FIG. 4 above. Selecting the Create Parlay button 504 displays a plurality of sports 508 in a sports selection area 506 and a plurality of games 512 in a game selection area 510. The parlay may include a predetermined number of games (e.g., 4 games in this embodiment), and a predicted parlay odds value 538, which may be increased or decreased using the arrow buttons 530.

The parlay includes a number of individual parlay game entries 540 that can be selected and customized by the player in a manner similar to the operations described above with respect to FIG. 4. For example, as shown in FIG. 5A, the first and second parlay game entries 540 have been completed, and the third parlay game entry 540 is being customized with individual sport, game, bet type, and amounts being selected.

As shown by FIG. 5B, once all of the parlay game entries 540 have been completed, a wager amount 526 and confidence level 528 can be selected in a manner similar to the operations described above with respect to FIG. 4. The player can then select the Place and Share Wager button 532 or the Place Wager button 534 in a manner similar to the operations described above with respect to FIG. 4.

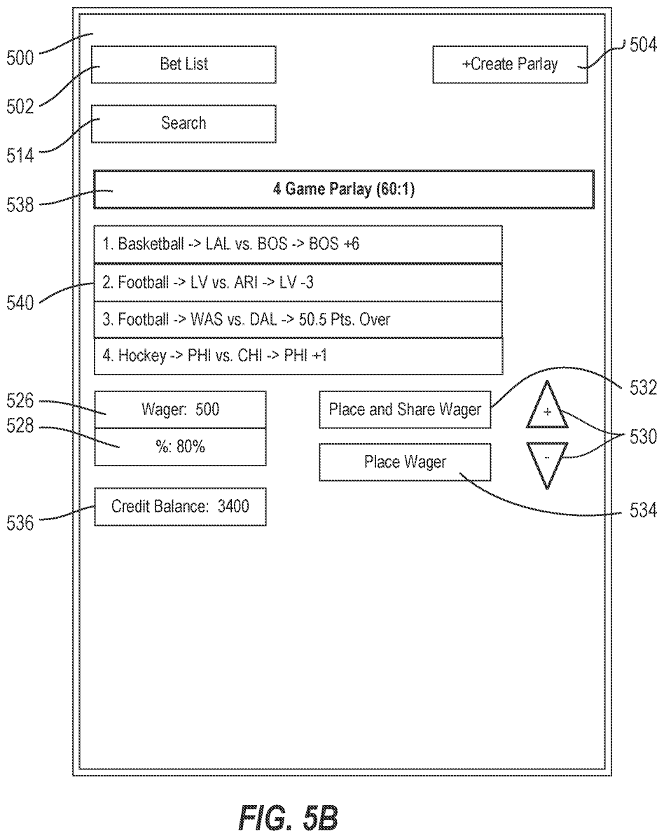

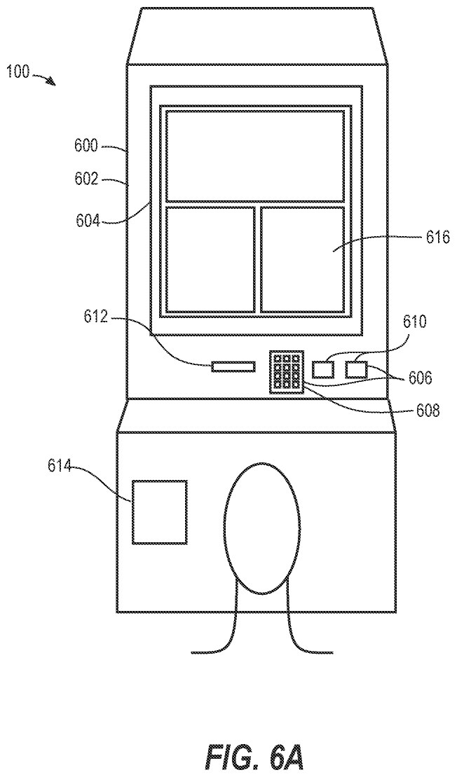

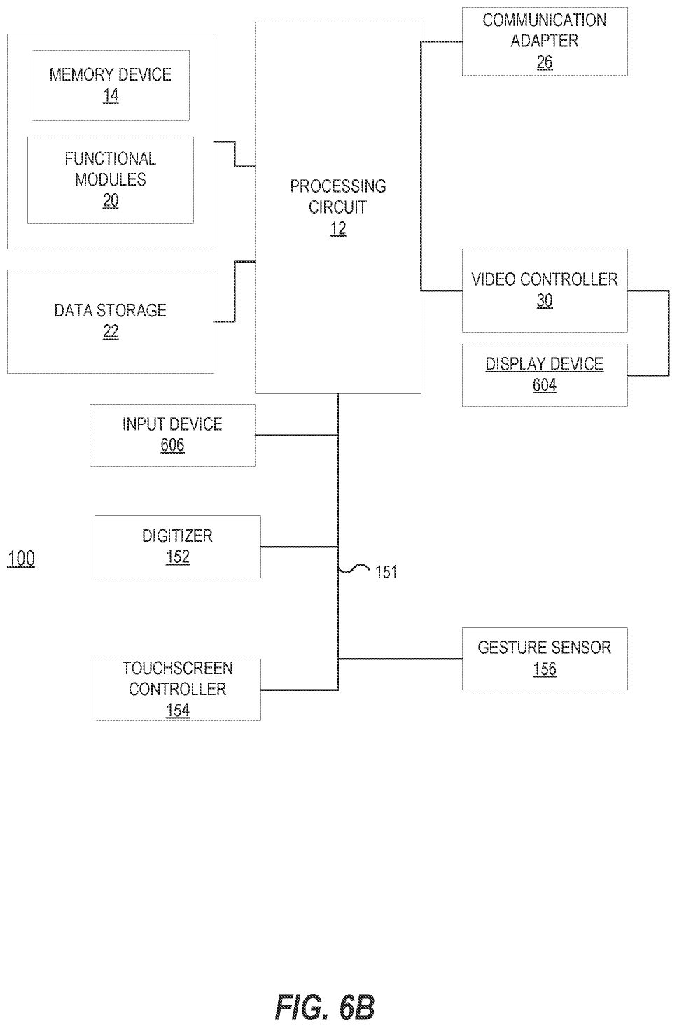

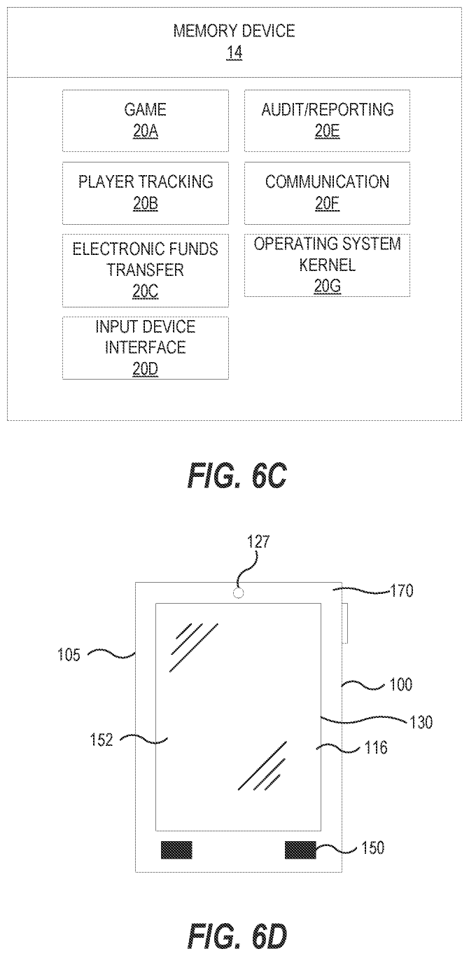

Embodiments herein may include different types of gaming devices. One example of a gaming device includes a gaming device 100 that can use gesture and/or touch-based inputs according to various embodiments is illustrated in FIGS. 6A, 6B, and 6C in which FIG. 6A is a perspective view of a gaming device 100 illustrating various physical features of the device, FIG. 6B is a functional block diagram that schematically illustrates an electronic relationship of various elements of the gaming device 100, and FIG. 6C illustrates various functional modules that can be stored in a memory device of the gaming device 100. The embodiments shown in FIGS. 6A to 6C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 6A and 6B. In this regard, FIG. 6A illustrates a gaming device 100 embodied in a dedicated gaming terminal 600, but it should be understood that other types of gaming devices, such as EGMs, sports gaming kiosks, mobile devices, tablets, smartphones, or other devices, may provide similar functionality for implementing features disclosed herein. In some embodiments, the gaming device 100 includes a housing 602 having a display device 604, and a plurality of input devices 606, such as a keypad 608, buttons 610, etc., for receiving user input for playing the wagering game and otherwise interacting with the gaming device 100. In some embodiments, the display device 604 may include a touchscreen interface for receiving user input as well. The display device 604 may also be a single display device or may include multiple display devices, such as a first display device for displaying video of the live sporting event and a second display device for displaying gaming and wagering information for example. The gaming device 100 may include additional specialized hardware as well, such as an acceptor 612, for receiving currency (i.e., bills and/or coins), tokens, credit or debit cards, or other physical items associated with monetary or other value. The gaming device 100 may also include a dispenser 614, for dispensing items, such as physical items having monetary or other value (e.g., awards or prizes) or other items.

The gaming device 100 may include a processor circuit and a memory coupled to the processor circuit. The memory may include machine-readable instructions that, when executed by the processor circuit, cause the processor circuit to perform operations for operating the gaming device 100 and/or other features described herein. In this example, the gaming terminal 600 may include a graphical user interface (GUI) 616 displayed by the display device 604 for providing the video and gaming information to the player.

In some embodiments, as shown in FIG. 6B, the input device(s) 606 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on the display device 604. Accordingly, any of the above-described input devices 606 may be provided as virtual buttons or regions on the display device 604.

Referring briefly to FIG. 6B, operation of the display device 604 may be controlled by a video controller 30 that receives video data from a processing circuit 12 or directly from a memory device 14 and displays the video data on the display screen.

Referring again to FIG. 6A, the display device 604 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device 604 may include a touch-screen with an associated touchscreen controller 154 and digitizer 152. The display device 604 may be of any suitable size, shape, and/or configuration. The display device 604 may include flat or curved display surfaces.

FIG. 6B is a block diagram that illustrates logical and functional relationships between various components of a gaming device 100. It should also be understood that components described in FIG. 6B may also be used in other computing devices, as desired, such as mobile computing devices, personal computers, lottery terminals, or other network-connected devices, for example. As shown in FIG. 6B, the gaming device 100 may include a processing circuit 12 (also referred to as a processor circuit herein) that controls operations of the gaming device 100. Although illustrated as a single processing circuit, multiple special purpose and/or general purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 6B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 6D.

The memory device 14 may store program code and instructions, executable by the processing circuit 12, to control the gaming device 100. The memory device 14 may also store other data such as image data, event data, player input data, and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

Various functional modules of that may be stored in a memory device 14 of a gaming device 100 are illustrated in FIG. 6C. Referring to FIG. 6C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, and an operating system kernel 20G. The player tracking module 20B keeps track of the play of a player. The electronic funds transfer module 20C communicates with a back end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules.

In some embodiments, a gaming device 100 includes a personal device, such as a desktop computer, a laptop computer, a mobile device (e.g., mobile phone or smartphone), a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. For example, a gaming device 100 may be a personal mobile phone that accesses the wireless gaming system via a mobile app downloaded to the device from an app store or other software marketplace or repository, which facilitates game play, registration, and/or authentication, etc. for the wireless gaming system. It should be appreciated that a gaming device or gaming machine as disclosed herein may be a device that has obtained approval from a regulatory gaming commission or a device that has not obtained approval from a regulatory gaming commission.

For example, referring to FIG. 6D, a gaming device 100 (which is a mobile gaming device 170 in this embodiment) may be implemented as a handheld device including a compact housing 105 on which is mounted a touchscreen display device 116 including a digitizer 152. One or more input devices 130 may also be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

Embodiments described herein may be implemented in various configurations for gaming devices 100, including but not limited to: (1) a dedicated gaming device, wherein the computerized instructions for controlling any games (which are provided by the gaming device) are provided with the gaming device; and (2) a changeable gaming device, where the computerized instructions for controlling any games (which are provided by the gaming device) are downloadable to the gaming device through a data network. In some embodiments, the computerized instructions for controlling any games are executed by at least one central server, central controller or remote host. In such a “thin client” embodiment, the central server remotely controls any games (or other suitable interfaces) and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory comprising machine-readable instructions that, when executed by the processor circuit, cause the processor circuit to:
receive data associated with an identification of a future offer wager on a future offer of a sporting event wager, the future offer wager comprising a wager amount and a predicted value for a wager parameter associated with the sporting event wager;
cause a placement of the future offer wager;
determine an actual value for the wager parameter of the sporting event wager;
compare the predicted value to the actual value of the wager parameter to determine a result of the future offer wager; and
in response to a determination that the future offer wager is successful, provide an award based on the comparison and the wager amount.

2. The system of claim 1, wherein the wager parameter comprises a point spread associated with the sporting event wager.

3. The system of claim 1, wherein the wager parameter comprises a point total associated with the sporting event wager.

4. The system of claim 1, wherein the wager parameter comprises odds associated with a sporting event outcome associated with the sporting event wager.

5. The system of claim 4, wherein the odds comprise money-line odds associated with a participant winning a sporting event associated with the sporting event wager.

6. The system of claim 4, wherein the sporting event wager comprises a plurality of sporting event outcomes, and
wherein odds comprise odds associated with occurrence of a predetermined subset of the plurality of sporting event outcomes.

7. The system of claim 6, wherein the predetermined subset of the plurality of sporting event outcomes comprises all of the plurality of sporting event outcomes.

8. The system of claim 1, wherein the instructions that compare the predicted value to the actual value of the wager parameter further cause the processor circuit to:
determine whether the predicted value is within a first predetermined range of the actual value; and
determine whether the predicted value is within a second predetermined range of the actual value, the second predetermined range larger than the first predetermined range.

9. The system of claim 8, wherein the instructions that provide an award based on the comparison and the wager amount further cause the processor circuit to:
provide a first award in response to a determination that the predicted value is within the first predetermined range; and
provide a second award in response to a determination that the predicted value is within the second predetermined range and not within the first predetermined range.

10. The system of claim 1, wherein the future offer wager further comprises a confidence value selection associated with the predicted value,
wherein the award is further based on the confidence value selection.

11. The system of claim 1, wherein the instructions further cause the processor circuit to:
share an indication of the future offer wager with a plurality of gaming devices;
determine whether an additional future offer wager has been placed via the plurality of gaming devices based on the indication of the shared future offer wager; and
in response to a determination that an additional future offer wager has been placed, provide an award to a player associated with the shared future offer wager.

12. A gaming device comprising:
a display device;
an input device;
a processor circuit; and
a memory comprising machine-readable instructions that, when executed by the processor circuit, cause the processor circuit to:
display, by the display device, an offer of a future offer wager on a future offer of a sporting event wager;
receive, by the input device, a selection of a predicted value for a wager parameter associated with the sporting event wager;
based on receipt of the selected predicted value, cause a placement of the future offer wager comprising the predicted value selection and a wager amount;
based on a comparison of the selected predicted value and an actual value for the wager parameter of the sporting event wager, provide an indication of a result of the future offer wager; and
based on a determination that the future offer wager is successful, provide an award based on the comparison and the wager amount.

13. The gaming device of claim 12, wherein the wager parameter comprises a point spread associated with the sporting event wager.

14. The gaming device of claim 12, wherein the wager parameter comprises a point total associated with the sporting event wager.

15. The gaming device of claim 12, wherein the wager parameter comprises odds associated with a sporting event outcome associated with the sporting event wager.

16. The gaming device of claim 15, wherein the odds comprise money-line odds associated with a participant winning a sporting event associated with the sporting event wager.

17. The gaming device of claim 15, wherein the sporting event wager comprises a plurality of sporting event outcomes, and
wherein odds comprise odds associated with occurrence of a predetermined subset of the plurality of sporting event outcomes.

18. The gaming device of claim 12, wherein the instructions that compare the predicted value to the actual value of the wager parameter further cause the processor circuit to:
determine whether the predicted value is within a first predetermined range of the actual value; and
determine whether the predicted value is within a second predetermined range of the actual value, the second predetermined range larger than the first predetermined range.

19. The gaming device of claim 18, wherein the instructions that provide an award based on the comparison and the wager amount further cause the processor circuit to:
provide a first award in response to a determination that the predicted value is within the first predetermined range; and
provide a second award in response to a determination that the predicted value is within the second predetermined range and not within the first predetermined range.

20. A method comprising:
receiving, by a processor circuit, data associated with an identification of a future offer wager on a future offer of a sporting event wager, the future offer wager comprising a predicted value for a wager parameter associated with the sporting event wager;
placing of the future offer wager by the processor circuit;
comparing, by the processor circuit, the predicted value to an actual value of the wager parameter to determine a result of the future offer wager; and
in response to a determination that the future offer wager is successful, providing an award based on the comparison.
